(19) United States
(12) Patent Application Publication
(10) Pub. No.: US 2019/0359106 A1
(43) Pub. Date: Nov. 28, 2019

(54) AIR CONDITIONING SEAT

(71) Applicant: TOYOTA BOSHOKU KABUSHIKI KAISHA, Aichi-ken (JP)

(72) Inventors: Hiroyuki SUZUKI, Aichi-ken (JP); Fumitoshi AKAIKE, Aichi-ken (JP)

(73) Assignee: TOYOTA BOSHOKU KABUSHIKI KAISHA, Aichi-ken (JP)

(21) Appl. No.: 16/417,098

(22) Filed: May 20, 2019

(30) Foreign Application Priority Data
May 23, 2018 (JP) 2018-098607

(51) Int. Cl. B60N 2/879; B60H 1/00; B60N 2/56; B60N 2/885

(52) U.S. Cl. CPC B60N 2/879; B60N 2/885; B60N 2/5628; B60H 1/00285

(57) ABSTRACT

An air conditioning seat including: an extension part; a guide; and a duct, wherein the duct has an overlapping part which overlaps an inner surface of an outer wall of the extension part in a moving direction of the extension part when the extension part is in an extension position and in an retraction position, wherein the guide has a guiding structure by which the inner surface of the outer wall in the extension position is set to an inwardly inclined state in which the inner surface of the outer wall is inclined forward with respect to a blowing direction of the duct or inclined inwardly in a seat width direction with respect to the blowing direction, and wherein an outlet port of the seat has an opening which is opened inwardly in a seat width direction from the inner surface of the outer wall of the extension part.

### CROSS-REFERENCE TO RELATED APPLICATIONS

This application claims priority from Japanese Patent Application No. 2018-098607 filed on May 23, 2018, the entire contents of which are incorporated herein by reference.

### TECHNICAL FIELD

The present disclosure relates to an air conditioning seat. Specifically, the present disclosure relates to an air conditioning seat having an outlet port through which wind is to be blown out from a lateral side of the seat toward an inner side.

### BACKGROUND ART

In the related art, a so-called air conditioning seat having a function of blowing out wind from a seat surface toward a seated person has been known (JP-A-2006-102193). Specifically, the seat surface is provided with outlet ports of wind, and the wind having passed through a seat inside is blown out from the outlet ports.

In the above technology, since the outlet ports are provided in lateral side regions avoiding contact with a body of the seated person, the wind blown out from the outlet ports is likely to be dispersed in unspecified directions, so that it is difficult to expose a specific part of a body of the seated person to the wind.

### SUMMARY

The present disclosure has been made to solve the problem, and an object thereof is to appropriately expose a specific part of a body of a seated person to wind from a lateral side of the seat.

According to an aspect of the present disclosure, there is provided an air conditioning seat having an outlet port through which wind is to be blown out from a lateral side of the seat toward an inner side, the air conditioning seat including: a standing plate-shaped extension part provided at the lateral side of the seat so that a surface thereof faces a seat width direction; a guide configured to guide movement of the extension part between an extension position at which the extension part extends forward from the lateral side of the seat beyond a seat main surface and a retraction position at which the extension part is retracted more rearward than the extension position; and a duct configured to blow out the wind from a fixed position along an inner surface of an outer wall of the extension part, wherein the duct has an overlapping part which is a pipe line and which overlaps the inner surface of the outer wall of the extension part in a moving direction of the extension part when the extension part is in the extension position and when the extension part is in the retraction position, wherein the guide has a guiding structure by which the inner surface of the outer wall of the extension part in the extension position is set to an inwardly inclined state in which the inner surface of the outer skull of the extension part is inclined forward with respect to a blowing direction of the duct or inclined inwardly in the seat width direction with respect to the blowing direction of the duct, and wherein the outlet port has an opening which is opened inwardly in the seat width direction from the inner surface of the outer wall of the extension part.

Accordingly, even when the extension part is extended to the extension position, it is possible to appropriately distribute the wind, which is to be blown out from the duct having the overlapping part with the extension part, in the extension direction along the inner surface of the outer wall of the extension part. Specifically, the extension part is in the inwardly inclined state, in which the inner surface of the outer wall is inclined inwardly with respect to the seat width direction, at the extension position, so that it is possible to appropriately distribute the wind blown out from the duct in the extension direction along the inner surface without dispersing the same in unspecified directions. Therefore, it is possible to appropriately expose a specific part of a body of a seated person to the wind from the outlet port at the lateral side of the seat, which is opened inwardly from the inner surface of the outer wall of the extension part in the seat width direction.

### BRIEF DESCRIPTION OF DRAWINGS

FIG. 1 is a perspective view depicting a schematic configuration of an air conditioning seat in accordance with a first exemplary embodiment;

FIG. 2 is a perspective view depicting a state where extension parts are retracted to a retraction position;

FIG. 3 is a plan view of FIG. 1;

FIG. 4 is a plan view of FIG. 2;

FIG. 5 is a side view of FIG. 1;

FIG. 6 is a side view of FIG. 2;

FIG. 7 is a sectional view taken along a line VII-VII of FIG. 5; and

FIG. 8 is a sectional view taken along a line VIII-VIII of FIG. 6.

### DETAILED DESCRIPTION

Hereinafter, exemplary embodiments of the present disclosure will be described with reference to the drawings.

### First Exemplary Embodiment

<Schematic Configuration of Air Conditioning Seat 1>

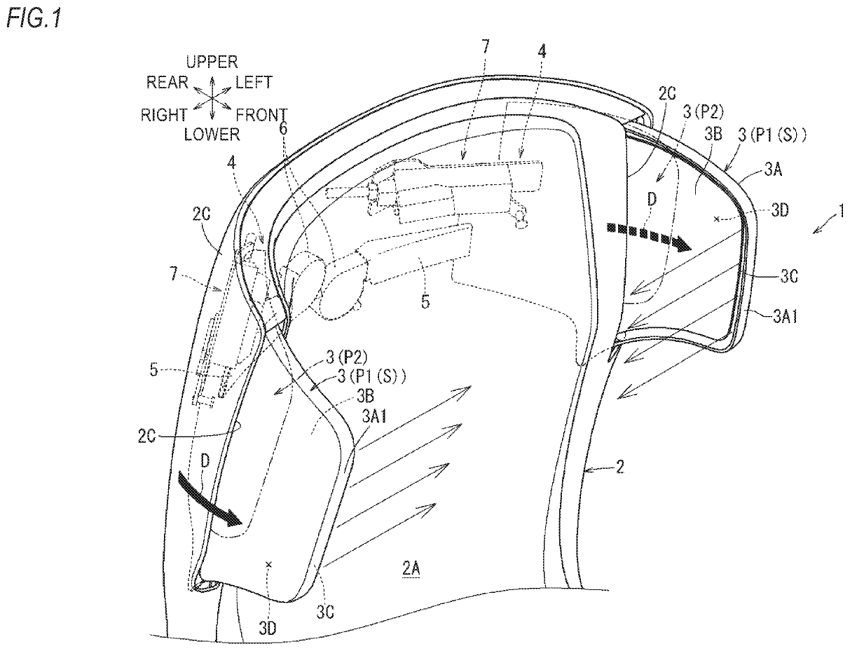

First, a configuration of an air conditioning seat 1 in accordance with a first exemplary embodiment is described with reference to FIGS. 1 to 8. Meanwhile, in the following description, front, rear, upper, lower, left and right directions indicate the respective directions shown in the respective drawings. Also, “the seat width direction” indicates the right and left direction of the air conditioning seat 1, and “the seat height direction” indicates the upper and lower direction of the air conditioning seat 1.

As shown in FIG. 1, the air conditioning seat 1 of the first exemplary embodiment is configured as a rear seat in an automobile, and includes a seat back 2, which is a backrest of a seated person, and a seat cushion (not shown), which is a seating part.

The seat back 2 is a so-called high back-type in which a head of the seated person can be rested in an upper region thereof. Also, the seat back 2 is a so-called shell type in which a back of the seated person is supported in a manner of being surrounded from both left and right sides. Also, both left and right sides of the upper region of the seat back 2, which is a headrest part, are provided with resin-made concave curved plate-shaped extension parts 3. Each of the extension parts 3 extends toward a front side (forward side) with a surface thereof facing the seat width direction.

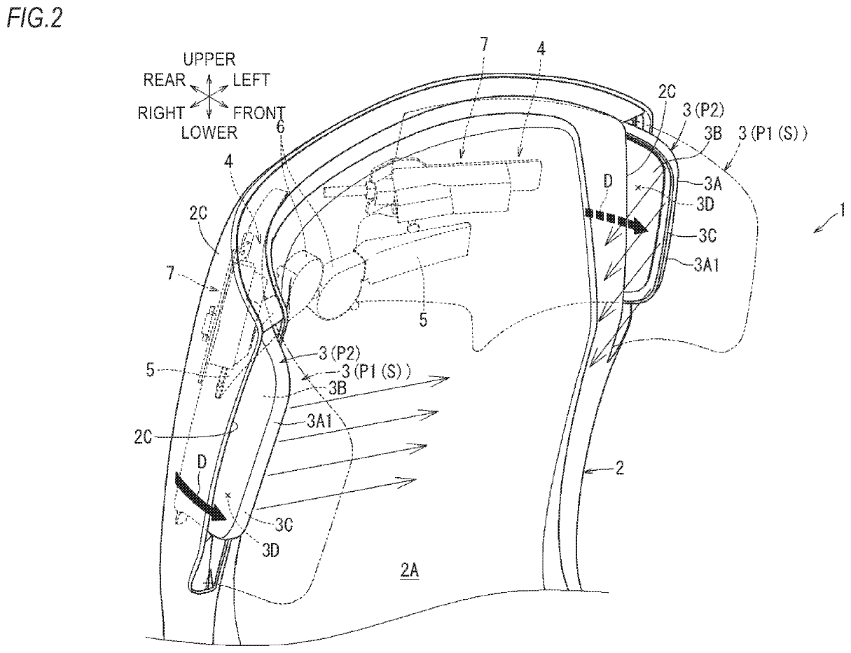

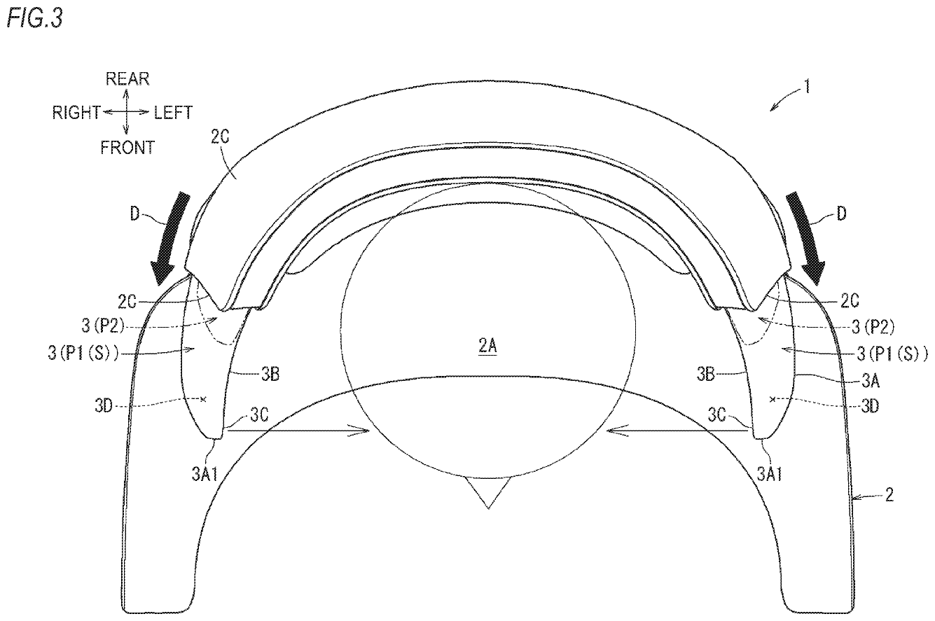

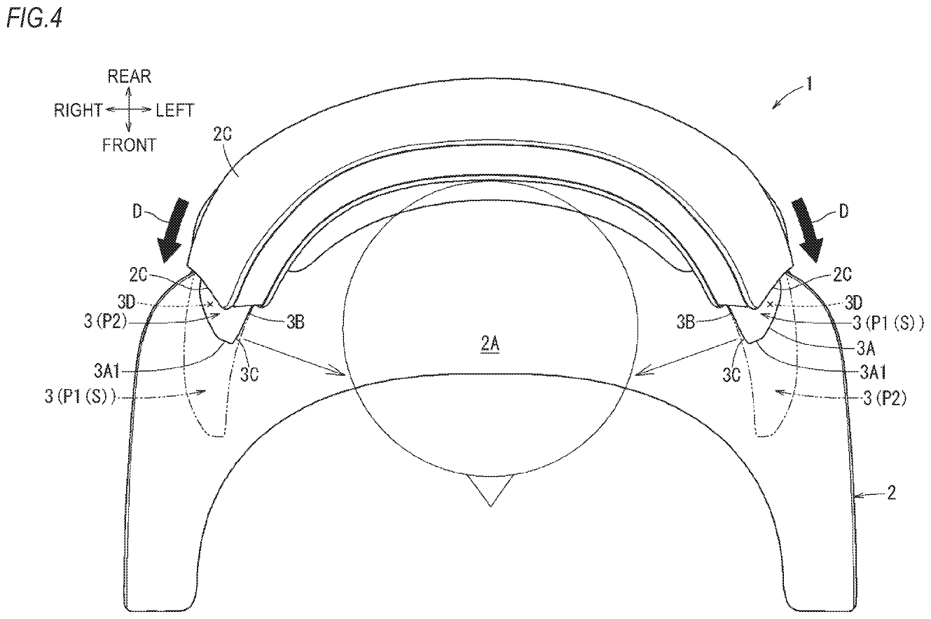

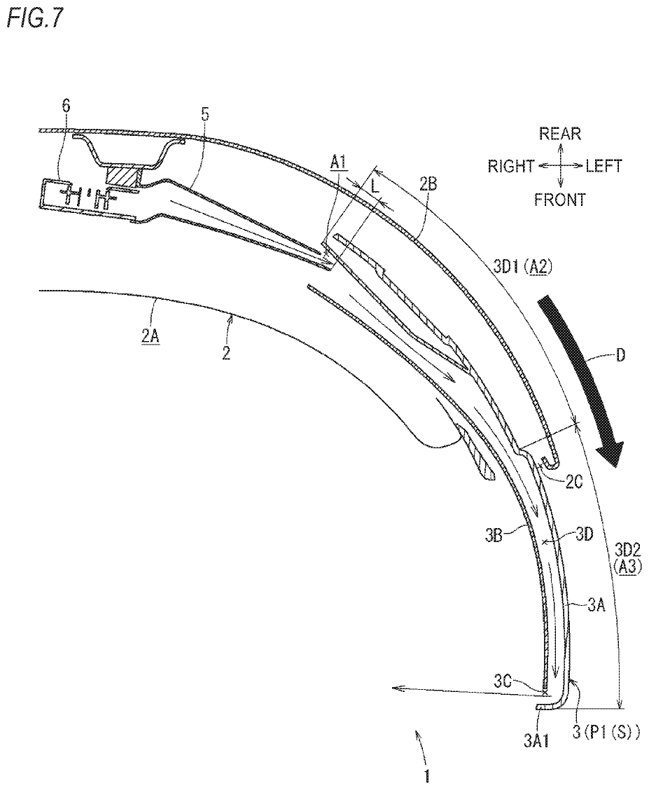

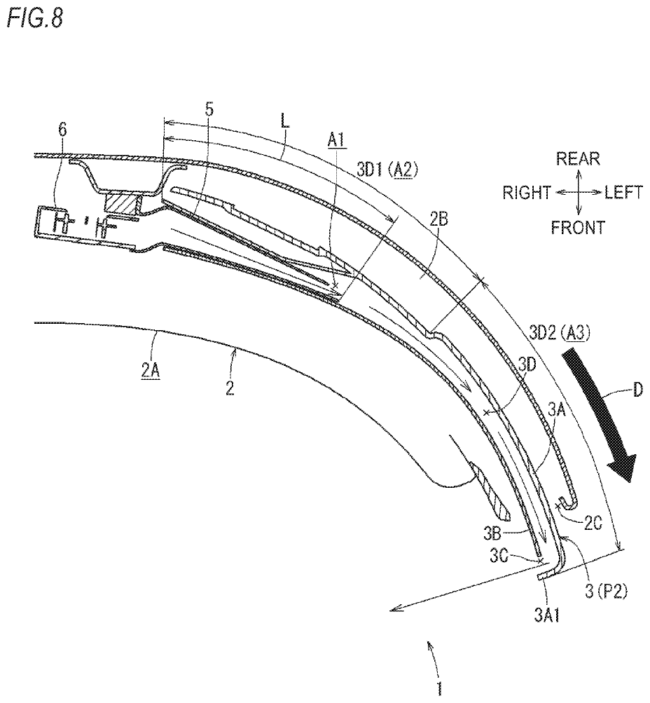

The extension parts 3 are configured to be individually driven between a retraction position P2 at which the extension parts 3 are retracted in a manner of being substantially stored in the left and right sides (lateral sides) of the seat back 2, as shown in FIGS. 2 and 4, and an extension position P1 at which the extension parts 3 extend in a manner of being developed from both the left and right sides of the seat back 2 toward the front side beyond a seat main surface 2A. Specifically, as shown in FIGS. 7 and 8, the respective extension parts 3 are configured to be extended to the extension position P1 shown in FIGS. 1 and 3 or to be retracted to the retraction position P2 shown in FIGS. 2 and 4 from elongated through-holes 2C formed at edge portions of both the left and right sides of the seat back 2 between the seat main surface 2A of a forward side and a shell wall 2B of a rear side.

As shown in FIGS. 2, 4, 6 and 8, in a state where the extension parts 3 are in the retraction position P2 where the extension parts 3 are fully retracted in both the left and right sides of the seat back 2, the extension parts 3 are mostly retracted in conformity to the concave curved shell shape of the seat back 2 and extending tip end portions thereof having outlet ports 3C formed therein extends to an outside. By the configuration, the respective extension parts 3 can secure wide opened spaces at both the left and right sides of a head of the seated person.

Also, as shown in FIGS. 1, 3, 5 and 7, in a state where the extension parts 3 are in the extension position P1 where the extension parts 3 fully extend forward from both the left and right sides of the seat back 2, the extension parts 3 extend forward along the concave curved shell shape of the seat back 2 and form standing plate-shaped covering parts, which have surfaces facing the seat width direction, at both the left and right sides of the seat back 2.

Specifically, as shown in FIGS. 3 and 7, in the state where the extension parts 3 are in the extension position P1, each extension part 3 is in an inwardly inclined state S in which the extension part 3 is erected more forward than the concave curved shape of the seat main surface 2A of the forward side configuring a backrest surface of the seat back 2 and is inclined inwardly with respect to the seat width direction. By the configuration, the respective extension parts 3 can deeply cover the head of the seated person from both the left and right sides, thereby securing a comfortable personal space. Also, when a lateral load resulting from corner traveling of a vehicle is applied to the head of the seated person, each extension part 3 in the state of the extension position P1 can softly receive the head from a side by the resin-made flexible structure extending in a cantilever shape.

In the state where the extension parts 3 are in the extension position P1 shown in FIGS. 1 and 3 and in the state where the extension parts 3 are in the retraction position P2 shown in FIGS. 2 and 4, wind blown out from left and right ducts 5 provided in the seat back 2 flows through the respective extension parts 3n, thereby blowing out the same from the outlet ports 3C toward the head of the seated person. At this time, each extension part 3 is configured to widely diffuse the wind blown out from each duct 5 from the outlet port 3C in the seat height direction and to expose the head of the seated person to the wind while appropriately distributing the wind blown out from each duct 5 in a narrowing shape in an extension direction D thereof, without dispersing the wind in unspecified directions in each extension part 3.

<Specific Configuration of Each Extension Part 3>

Subsequently, each extension part 3, and a configuration of moving the same between the extension position P1 shown in FIGS. 1 and 3 and the retraction position P2 shown in FIGS. 2 and 4 are described in detail. As shown in FIGS. 7 and 8, each extension part 3 is formed by a substantially concave curved hollow plate. Specifically, each extension part 3 is attached in a manner of forming a space 3D between an outer wall 3A and an inner wall 3B, each of which has a concave curved shape, and is configured to distribute the wind, which is to be blown out from the duct 5 (which will be described later), in an in-plane direction along the space 3D between the outer wall 3A and the inner wall 3B.

A tip end of the outer wall 3A in the extension direction D is formed with an cave part 3A1 extending in a form of bending an inner surface thereof toward the inner wall 3B. The inner wall 3B is formed with a space between the cave part 3A1 of the outer wall 3A, so that an elongated slit becoming the outlet port 3C is formed between the inner wall 3B and the eave part 3A1. An opposite end portion, with respect to the extension direction D, of each extension part 3 is connected with the duct 5 fixed at a fixed position in the seat back 2. Each duct 5 is connected to a blower 6 fixed at a fixed position in the seat back 2, and is configured to blow out the wind, which is to be blown out from each blower 6, toward an inside of each extension part 3.

Each duct 5 is not directly coupled with each extension part 3 and a tip end thereof is instead inserted into the space 3D between the outer wall 3A and the inner wall 3B of each extension part 3, thereby forming a wind distributing path continuing to each extension part 3. Each duct 5 is provided in the space 3D between the outer wall 3A and the inner wall 3B of each extension part 3 while being directed to a direction extending with being curved in a concave curved shape toward an outer side in the seat width direction, which is the in-plane direction of the outer wall 3A and the inner wall 3B. Specifically, each duct 5 is provided while being inserted in the space 3D between the outer wall 3A and the inner wall 3B of each extension part 3 so that in both cases where each extension part 3 is located at the retraction position P2 shown in FIG. 8 and at the extension position P1 shown in FIG. 7, a pipe line part thereof inserted in each extension part 3 has an overlapping part L in which the pipe line part overlap the outer wall 3A and the inner wall 3B of each extension part 3 in the extension direction D.

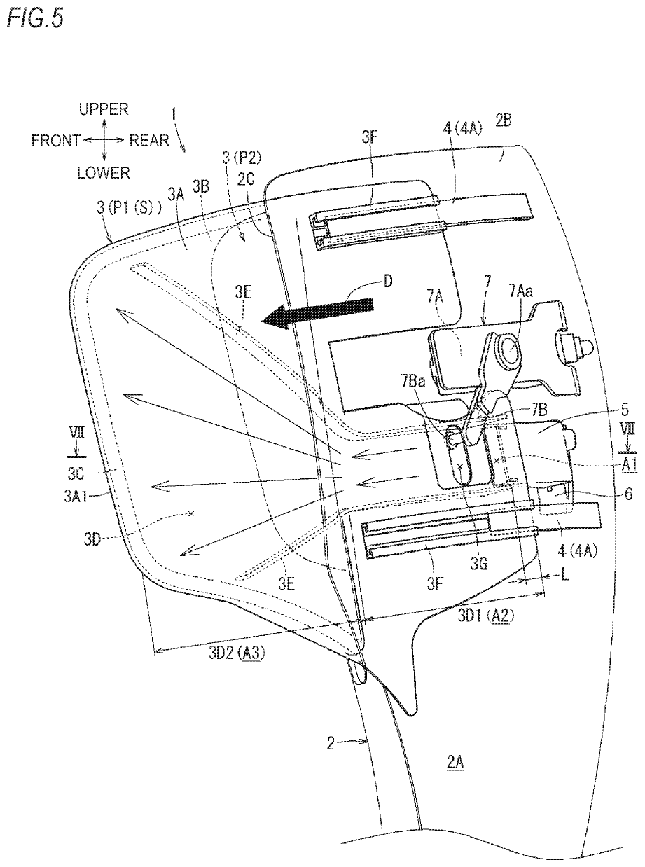

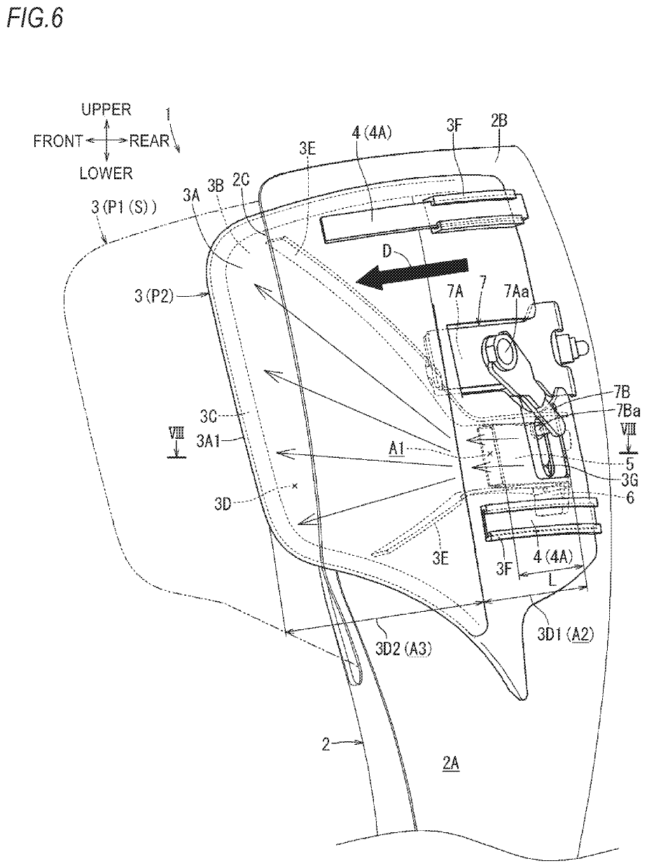

Also, as shown in FIGS. 5 and 6, each extension part 3 is provided with a pair of upper and lower ribs 3E configured to partition the space 3D between the outer wall 3A and the inner wall 3B. By the respective ribs 3E, the wind blown out from each duct 5 into the space 3D of each extension part 3 is distributed in the extension direction D along the space 3D surrounded by the outer wall 3A, the inner wall 3B and each rib 3E. Specifically, a pipe line part in an overlapping region A2, which overlaps the overlapping part L of each duct 5, of each extension part 3 is formed as a narrowed part 3D1, which extends in the extension direction D while surrounding each duct 5 in a pipe line shape slightly larger than each duct 5, by each rib 3E.

Also, a pipe line part in a non-overlapping region A3, which does not overlap the overlapping part L of each duct 5, of each extension part 3 is formed as a diffusion part 3D2 coupled with the pipe line part in the overlapping region A2, extending in the extension direction D and having a pipe diameter gradually increasing toward both directions of the seat height direction. By the configuration, it is possible to straighten the wind blown out from the duct 5 so that the wind can efficiently flow in the extension direction D along the narrowed part 3D1 having a narrow diffusion width, and to blow out the wind in a form of widely diffusing the same in the seat height direction in the diffusion part 3D2 having a wide diffusion width, without dispersing the wind in the unspecified directions in the blowing outlet region A1 of the duct 5 or stagnating the same.

Specifically, while each duct 5 is directed to the direction extending with being curved in a concave curved shape toward the outer side in the seat width direction, which is the in-plane direction of each extension part 3, the outer wall 3A of each extension part 3 has an angled state all the time in which each extension part 3 has an inwardly inclined shape which is curved forward relative to the direction in which each duct 5 is directed to. For this reason, each extension part 3 can appropriately guide and distribute the wind blown out from each duct 5 in the extension direction D along the inwardly inclined angled surface of the outer wall 3A.

<Moving Structure of Each Extension Part 3>

Each extension part 3 is configured to be movable between the extension position P1 shown in FIGS. 1 and 3 and the retraction position P2 shown in FIGS. 2 and 4 by guides 4 provided between the extension part and the seat back 2, as follows. That is, as shown in FIGS. 5 and 6, each guide 4 configured to move and guide each extension part 3 relative to the seat back 2 includes: a pair of upper and lower curved rails 4A provided in the left and right sides of the seat back 2; and a pair of upper and lower sliders 3F of each extension part 3, each of which is fitted with each curved rail 4A so as to be slidable along the curved rail 4A. Here, each curved rail 4A corresponds to the “rail structure” of the present disclosure.

Each curved rail 4A is attached on an inner peripheral surface of the shell wall 29 of the seat back 2, and extends with being curved in the extension direction D along the concave curved shell shape of the shell wall 2B. The slider 3F of each extension part 3 is formed on the upper and lower sides of the outer wall 3A between which the narrowed part 3D1 of each extension part 3 is located, and is formed in a thinned concave rail shape which is fitted to each curved rail 4A.

Each extension part 3 whose movement relative to the seat back 2 is to be guided by the respective guides 4 can be freely moved between the extension position P1 shown in FIGS. 1 and 3 and the retraction position P2 shown in FIGS. 2 and 4 or can be stopped at the moved position by a drive unit 7 provided in each of the left and right sides of the seat back 2. Specifically, as shown in FIGS. 5 and 6, each drive unit 7 includes a motor 7A provided in each of the left and right sides of the seat back 2 and a link 7B coupled to a rotation output shaft 7Aa of the motor 7A.

Each link 79 has a pin 7Ba provided at a tip end thereof and slidably and axis-rotatably fitted in each long hole 3G formed in the outer wall 3A of each extension part 3 and extending in an elongated shape. By the configuration, each link 7B is rotated by receiving a rotational drive force from the rotation output shaft 7Aa of each motor 7A, so that the pin 7Ba provided at the tip end is slid in each long hole 3G and each extension part 3 is thus extended in the extension direction D or retracted in the opposite direction. When the rotation of the rotation output shaft 7Aa of each motor 7A is stopped, each link 7B is stopped at the moved position by a braking force thereof.

When each extension part 3 is moved from the retraction position P2 shown in FIGS. 2 and 4 to the extension position P1 shown in FIGS. 1 and 3 by the drive of each drive unit 7, each extension part 3 is gradually inclined to the inwardly inclined state S in association with the forward extending movement by the guide of the curved rail structures of the respective guides 4 shown in FIGS. 5 and 6. Due to this moving locus, even when each extension part 3 is moved to any movement position, the outlet port 3C provided at the tip end of the extension part takes an inwardly inclined posture facing the head of the seated person, so that it is possible to more appropriately expose a specific part of the body of the seated person to the wind.

<Summary>

The air conditioning seat 1 of the first exemplary embodiment has the following configurations. That is, the air conditioning seat 1 is an air conditioning seat (1) having an outlet port (3C) through which wind is to be blown out from a lateral side of the seat toward an inner side. The air conditioning seat (1) includes a standing plate-shaped extension part (3) provided at the lateral side of the seat so that a surface thereof faces a seat width direction, a guide (4) configured to guide movement of the extension part (3) between an extension position (P1) at which the extension part extends forward from the lateral side of the seat beyond a seat main surface (2A) and a retraction position (P2) at which the extension part is retracted more rearward than the extension position (P1), and a duct (5) configured to blow out the wind from a fixed position along an inner surface of an outer wall (3A) of the extension part (3).

The duct (5) has an overlapping part (L) which is a pipe line and which overlaps the inner surface of the outer wall (3A) of the extension part (3) in a moving direction of the extension part (3) when the extension part (3) is in the extension position (P1) and when the extension part (3) is in the retraction position (P2). The guide (4) has a guiding structure by which the inner surface of the outer wall (3A) of the extension part (3) in the extension position (P1) is set to an inwardly inclined state (S) in which the inner surface of the outer wall (3A) of the extension part (3) is inclined forward with respect to a blowing direction of the duct (5) or inclined inwardly in the seat width direction with respect to the blowing direction of the duct (5). The outlet port (3C) has an opening which is opened inwardly in the seat width direction from the inner surface of the outer wall (3A) of the extension part (3).

By the above configuration, even when the extension part (3) is extended to the extension position (P1), it is possible to appropriately distribute the wind, which is to be blown out from the duct (5) having the overlapping part (L) with the extension part (3), in the extension direction (D) along the inner surface of the outer wall (3A) of the extension part (3). Specifically, the extension part (3) is in the inwardly inclined state (5), in which the inner surface of the outer wall (3A) is inclined inwardly with respect to the seat width direction, at the extension position (P1), so that it is possible to appropriately distribute the wind blown out from the duct (5) in the extension direction (D) along the inner surface without dispersing the same in unspecified directions. Therefore, it is possible to appropriately expose a specific part of the body of a seated person to the wind from the outlet port (3C) at the lateral side of the seat, which is opened inwardly from the inner surface of the outer wall (3A) of the extension part (3) in the seat width direction.

Also, the air conditioning seat (1) further includes an inner wall (3B) sandwiching a blowing outlet region (A1) of the duct (5) together with the inner surface of the outer wall (3A) of the extension part (3). By the configuration, it is possible to more appropriately distribute the wind blown out from the duct (5) in the extension direction (D) along a space (3D) between the outer wall (3A) and the inner wall (3B) of the extension part (3).

Also, the inner wall (3B) is integrated with the extension part (3) to configure a covering part which is configured to cover a body of the seated person from the lateral side when the extension part (3) is in the extension position (P1). By the configuration, it is possible to move the inner wall (3B) integrally with the extension part (3) between the extension position (P1) and the retraction position (P2), and to cover the body of the seated person from the lateral side by the inner wall (3B) with good appearance.

Also, the guiding structure of the guide (4) is a gradually changing structure by which the inner surface of the outer wall (3A) of the extension part (3) is guided to be gradually inclined toward the inwardly inclined state (S) in association with the movement of the extension part (3) from the retraction position (P2) toward the extension position (P1). By the configuration, the inner surface of the extension part (3) can be set to the inwardly inclined posture facing the body of the seated person at any movement position, so that it is possible to more appropriately expose the specific part of the body of the seated person to the wind.

Also, the guiding structure of the guide (4) is configured to gradually change a direction of the inner surface of the outer wall (3A) of the extension part (3) by guiding the extension part (3) with a curved rail structure (4A). By the configuration, it is possible to obtain the guiding structure by which the extension part (3) is gradually inclined to the inwardly inclined state from the retraction position (P21) toward the extension position (P1), by the simple configuration of using the rail structure (4A).

Also, an overlapping region (A2) of the extension part (3), which overlaps the overlapping part (L) of the duct (5), includes a narrowed part (3D1) whose diffusion width, within which the wind blown out from the duct (5) is to be diffused in an in-plane direction, is narrower than the diffusion width of a non-overlapping region (A3) of the extension part (3) which does not overlap the overlapping part (L). By the configuration, it is possible to always blow out the wind, which is to be blown out from the duct (5), from the narrowed part (3D1) whose diffusion width is narrow to the non-overlapping region (A3) whose diffusion width is wide. Therefore, it is possible to cause the wind blown out from the duct (5) to appropriately diffuse and flow in the in-plane direction toward the extension direction (D) without dispersing the same in the unspecified directions in the blowing outlet region (A1) of the duct (5).

Although one exemplary embodiment of the present disclosure has been described, the present disclosure can be implemented in a variety of forms, in addition to the above exemplary embodiment. For example, the air conditioning seat of the present disclosure can be applied to not only a seat for a non-vehicle such as furniture but also a seat for diverse vehicles including an automobile, a train, an airplane, a ship and the like. The air conditioning seat can be applied to other seat structures such as a seat cushion, an ottoman, a headrest and the like, in addition to the seat back.

Also, the extension part may be provided to only one of the left and right sides. Also, when the extension part is provided to each of the left and right sides, the left and right extension parts may be configured to move between the extension position and the retraction position in a synchronization manner or individually freely. The extension part may be electrically driven or manually driven.

Also, the extension position of the extension part may be any position at which the extension part extends forward beyond the seat main surface. Also, the retraction position may be a position at which the extension part extends forward beyond the seat main surface. Also, the extension part may have the outer wall without the inner wall. Also, the inner wall may be integrated with the duct, other than the extension part. Also, the air conditioning seat may be configured without the inner wall. The outer wall of the extension part may be set to the inwardly inclined state at the extension position due to the curved shape thereof. Alternatively, the outer wall may have a flat plate shape which is set to the inwardly inclined state inclined forward with respect to the blowing direction of the duct or inclined inwardly in the seat width direction with respect to the blowing direction of the duct at the extension position.

Also, the inwardly inclined state, in which the inner surface of the outer wall of the extension part in the extension position is inclined forward with respect to the blowing direction of the duct or inclined inwardly in the seat width direction with respect to the blowing direction of the duct, indicates a state in which the inner surface is inclined forward when the blowing direction of the duct faces straightly in the seat width direction and a state in which the inner surface is inclined inwardly in the seat width direction when the blowing direction of the duct faces forward straightly. Since the inwardly inclined state is determined with respect to the blowing direction of the duct, the inner surface may be inclined as described above with respect to the blowing direction of the duct.

What is claimed is:

1. An air conditioning seat having an outlet port through which wind is to be blown out from a lateral side of the seat toward an inner side, the air conditioning seat comprising:
a standing plate-shaped extension part provided at the lateral side of the seat so that a surface thereof faces a seat width direction;
a guide configured to guide movement of the extension part between an extension position at which the extension part extends forward from the lateral side of the seat beyond a seat main surface and a retraction position at which the extension part is retracted more rearward than the extension position; and
a duct configured to blow out the wind from a fixed position along an inner surface of an outer wall of the extension part,
wherein the duct has an overlapping part which is a pipe line and which overlaps the inner surface of the outer wall of the extension part in a moving direction of the extension part when the extension part is in the extension position and when the extension part is in the retraction position,
wherein the guide has a guiding structure by which the inner surface of the outer wall of the extension part in the extension position is set to an inwardly inclined state in which the inner surface of the outer wall of the extension part is inclined forward with respect to a blowing direction of the duct or inclined inwardly in the seat width direction with respect to the blowing direction of the duct, and
wherein the outlet port has an opening which is opened inwardly in the seat width direction from the inner surface of the outer wall of the extension part.

2. The air conditioning seat according to claim 1, further comprising:
an inner wall sandwiching a blowing outlet region of the duct together with the inner surface of the outer wall of the extension part.

3. The air conditioning seat according to claim 2,
wherein the inner wall is integrated with the extension part to configure a covering part which is configured to cover a body of the seated person from the lateral side when the extension part is in the extension position.

4. The air conditioning seat according to claim 1,
wherein the guiding structure of the guide is a gradually changing structure by which the inner surface of the outer wall of the extension part is guided to be gradually inclined toward the inwardly inclined state in association with the movement of the extension part from the retraction position toward the extension position.

5. The air conditioning seat according to claim 4,
wherein the guiding structure of the guide is configured to gradually change a direction of the inner surface of the outer wall of the extension part by guiding the extension part with a curved rail structure.

6. The air conditioning seat according to claim 1,
wherein an overlapping region of the extension part, which overlaps the overlapping part of the duct, includes a narrowed part whose diffusion width, within which the wind blown out from the duct is to be diffused in an in-plane direction, is narrower than the diffusion width of a non-overlapping region of the extension part which does not overlap the overlapping part.
